(19) United States
(12) Patent Application Publication
(10) Pub. No.: US 2007/0113854 A1
(43) Pub. Date: May 24, 2007

(54) INJECTION CONTROL FOR NON-INVENTED MASK

(75) Inventor: Patrick John Mcauliffe, BELLA VISTA (AU)

Correspondence Address: NIXON & VANDERHYE, PC, 901 NORTH GLEBE ROAD, 11TH FLOOR, ARLINGTON, VA, 22203, US

(73) Assignee: RESMED LIMITED, BELLA VISTA (AU)

(21) Appl. No.: 10/582,479

(22) PCT Filed: Dec. 8, 2004
(86) PCT No.: PCT/AU04/01732

§ 371 Date: Jul. 6, 2006

Related U.S. Application Data
(60) Provisional application No. 60/528,716, filed on Dec. 12, 2003.

(51) Int. Cl. A62B 23/02

(52) U.S. Cl. 128/205.29; 128/205.27

(57) ABSTRACT

A mask assembly (30) is provided with a filter assembly (48) to filter gas exhaled by a patient during the administration of ventilatory therapy, e.g. CPAP or bi-level treatment, to reduce or eliminate the possibility of cross-infection to other patients or the physician in a clinical setting.

### CROSS REFERENCE TO PRIORITY APPLICATION

This application claims the benefit of U.S. Provisional Application No. 60/528,716, filed Dec. 12, 2003, incorporated by reference in its entirety.

### BACKGROUND OF THE INVENTION

This invention relates to the field of masks, in particular, this invention relates to the field of reducing risk of cross-infection during the administration of non-invasive positive pressure ventilation (NIPPV) therapy or continuous positive airway pressure (CPAP) therapy. Of course, the disclosure may also have application to ventilators in general.

FIG. 1 illustrates a prior art mask assembly 10 including a mask shell 12 including an inlet 14 and at least one strap connection point 18 which provides a point of attachment for headgear (not shown). A facial interface in the form of face contacting cushion 16 is attached to the shell to thereby define an interior chamber into which pressurized breathable gas is introduced via the inlet 14. The shell 12 includes at least one aperture, which in this case is covered with an elastomeric insert 20 including a plurality of vent openings 22. Although the mask assembly 10 is shown to be a nasal mask, it could also be a full face mask. The nasal mask of FIG. 1 is fully described in U.S. Pat. No. 6,561,190, assigned to ResMed Limited and incorporated herein by reference in its entirety.

The administration of positive airway pressure therapy requires that exhaled air is adequately exhausted from the mask to prevent rebreathing of expired CO₂ by the patient.

When using bi-level or CPAP devices, exhaled air is exhausted from the mask via one or more vents that are built into the mask or attached proximally to the mask, as shown in FIG. 1. During therapy, fresh air from the device flushes out exhaled air through the vents. The exhaled gases, including aerosols, are exhausted from the mask vents under pressure into the surrounding atmosphere. For highly infectious respiratory diseases, there may be potential to increase the risk of cross-infection from the patient to healthcare workers or to other patients. Accordingly, it may be desirable to create a mask that eliminates or at least reduces the risk of cross-infection due to unfiltered venting during positive pressure therapy.

### BRIEF SUMMARY OF THE INVENTION

According to one aspect of the invention, a mask is provided with a filter or other device which filters gas exhausted by a patient. In one preferred form, the mask is a non-vented mask.

It is another aspect of the invention to provide a nasal or full face mask with a filter assembly suitable to reduce the risk of cross-infection during positive airway pressure therapy.

In accordance with an embodiment of the invention, a mask assembly is provided with a mask shell having an inlet and a cushion provided to the mask shell. A source of pressurized breathable gas is provided to the interior of the mask shell, for delivery to the airways of the patient. A filter assembly is provided in communication with the shell to filter gas exhaled by the patient. The filter assembly may be connected directly to the mask shell, so as to communicate the interior of the mask shell to the atmosphere via a filter, or the filter assembly may be connected to a joint, e.g., an elbow or a T, that is provided to the inlet of the mask shell. The filter assembly may be provided at one or more ends of the joint, e.g., at the inlet and outlet ends of a T-joint.

In still another aspect, there is provided a patient interface configured for connection to a patient in use, the patient interface being in communication with a source of gas pressurized above atmospheric pressure, and a filter assembly configured to receive gas exhaled by the patient in use, whereby the exhaled gas is vented to atmosphere following passage through said filter assembly.

These and other aspects of the invention will be described in or apparent from the following description of preferred embodiments.

### BRIEF DESCRIPTION OF THE DRAWINGS

Preferred embodiments will be described with reference to the following drawings, in which like reference numbers indicate like parts and wherein:

FIG. 1 illustrates a prior art mask assembly;

FIG. 2 illustrates a first embodiment of a mask assembly according to the present invention;

FIG. 3 illustrates a top view of the filter assembly shown in FIG. 2;

FIG. 4 illustrates the mask assembly of FIG. 2 in use;

FIG. 5 illustrates a second embodiment of the present invention;

FIG. 6 illustrates a third embodiment of the present invention;

FIG. 7 illustrates a fourth embodiment of the present invention;

FIG. 8 illustrates a fifth embodiment according to the present invention;

FIG. 9 illustrates a sixth embodiment according to the present invention;

FIG. 10 illustrates a seventh embodiment according to the present invention; and

FIG. 11 illustrates an eighth embodiment according to the present invention.

### DETAILED DESCRIPTION OF ILLUSTRATED EMBODIMENTS

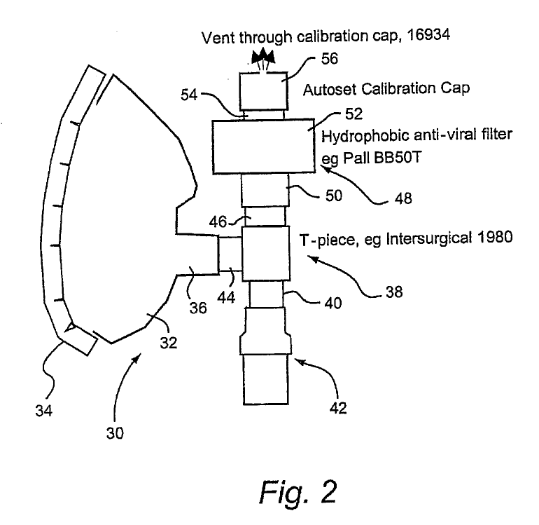

Preferred embodiments of the invention will be described in relation to FIGS. 2 through 11 in which like reference numbers indicate like parts.

FIG. 2 is a schematic view of a mask assembly 30 according to a first embodiment of the present invention. The mask assembly 30 includes a mask shell 32 having a face contacting portion in the form of a cushion 34, and an inlet 36. The mask shell and cushion are commercially available in various sizes from ResMed Limited. Of course, these and other commercially available components described herein are only examples. Other masks, shells and cushions are also available from ResMed Limited and other OEMs.

A T-shaped connection joint 38 includes an inlet 40 which is provided with a source of pressurized breathable gas via air delivery tube 42. The joint 38 includes a conduit 44 through which breathable gas is supplied to the patient and through which exhaled air (including CO₂) is exhausted. The joint 38 includes an outlet conduit 46 that is connected to a filter assembly 48. The filter assembly 48 includes an inlet 50, a central chamber 52 and an outlet 54. Preferably, the filter assembly 48 is hydrophobic such as is commercially available from Pall, Part No. BB50T. The outlet 54 is connected to a calibration cap 56 which is currently available from ResMed Limited, Part No. 16934. Also, the joint 38 is commercially available from Intersurgical, Part No. 1980.

As shown in FIG. 2, air is directed through a filter 58 of the filter assembly 48, and then passes through one or more orifices in the calibration cap 56 to atmosphere.

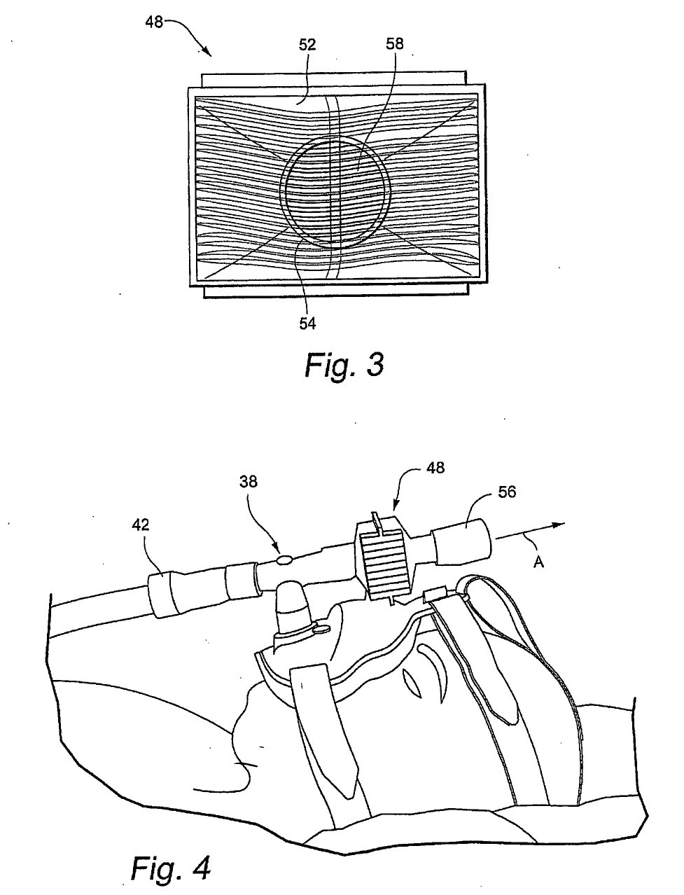

FIG. 3 is a top view of the filter assembly 48 without the calibration cap 56. The filter assembly includes a filter 58 which is placed within main chamber 52 of the filter assembly.

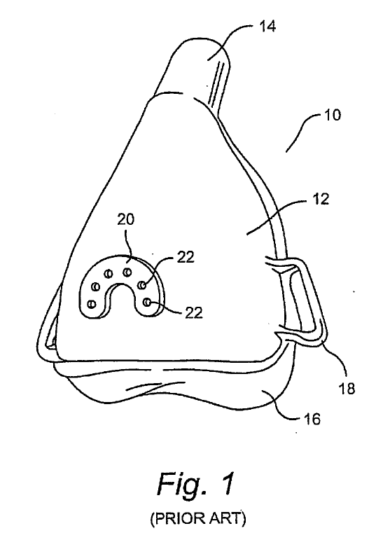

FIG. 4 illustrates mask assembly 30 in use on a patient P. In FIGS. 1-3, each of the conduit portions are preferably connected using male and female connections, e.g., having a standard diameter of 22 or 15 mm. It should be noted that these dimensions are merely illustrative of this embodiment, and that other orientations, connections and dimensions are within the scope of the present invention.

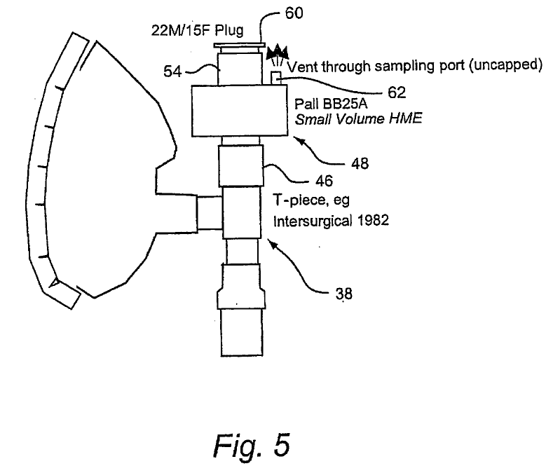

FIG. 5 illustrates a second embodiment of the present invention which differs from the embodiment of FIG. 2 in regard to the vent assembly 48. In FIG. 5, the vent assembly 48 is commercially available from Pall, Part No. BB25A. Vent assembly 48 includes a plug 60 and a vent port 62 which in this embodiment is preferably uncapped. In FIG. 5, the T-shaped joint 38 also has a slightly different configuration in that the outlet 46 is a female part rather than a male part.

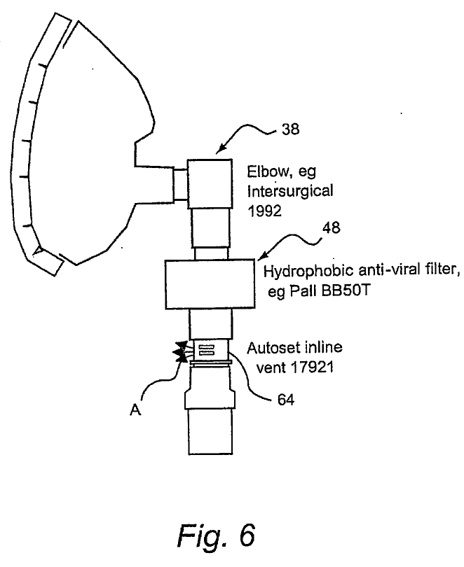

FIG. 6 illustrates a third embodiment of the present invention which has another configuration. In particular, the mask assembly includes an elbow joint 38 rather than a T-shaped joint which is available from Intersurgical, Part No. 1992. The elbow joint 38 is connected to filter assembly 48 which is similar to that shown in FIG. 2. The filter assembly 48 in turn is connected to an in-line vent 65 commercially available from ResMed Limited, Part No. 17921. As indicated by the arrows A in FIG. 6, exhaust is achieved via in-line vent 64. In other words, gas or CO₂ gas exhaled by the patient passes through the elbow joint 38 and filter assembly 48 and is then exhausted via in-line vent 64 following filtering in the filter assembly 48.

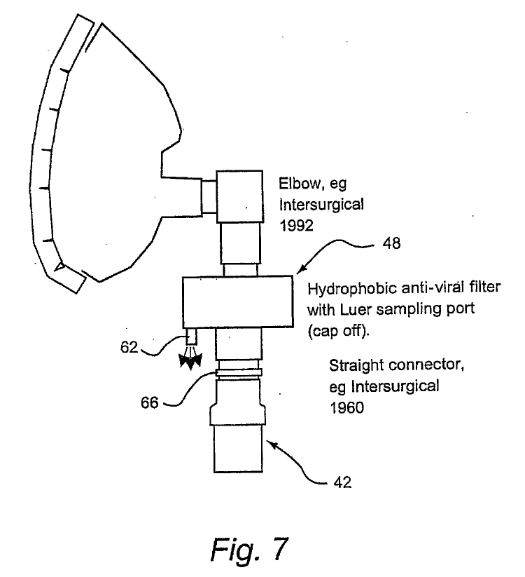

FIG. 7 illustrates a fourth embodiment of the present invention which is similar to that shown in FIG. 6. The main difference in the embodiment of FIG. 7 is that the filter assembly 48 is similar to that shown in FIG. 5 where the filter air is exhausted through the vent port 62 rather than through the in-line vent 64 shown in FIG. 6. The filter assembly 48 and the air delivery tube 42 are connected via a straight connector 66, available from Intersurgical, Part No. 1960.

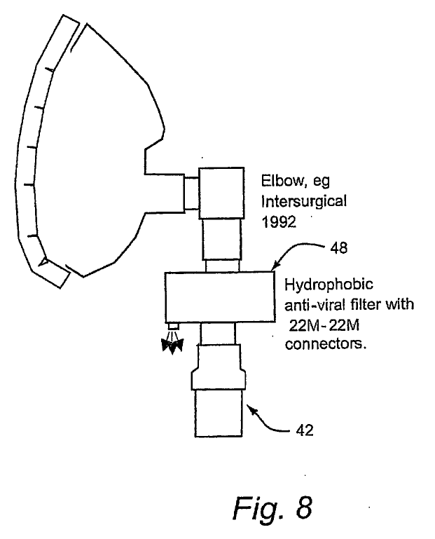

FIGS. 8-11 illustrate further assemblies according to the present invention, including, e.g. filter assemblies that are not commercially available or “off-the-shelf”. These embodiments include modified components (e.g., housings, vents, etc.) or operating characteristics (vent flow, etc.) that may have some benefit for the environment and application of NIPPV or CPAP. Of course, modifications to other components, such as the mask, can also be made to optimize performance.

FIG. 8 illustrates a fifth embodiment of the present invention which is similar to the embodiment of FIG. 7. The main difference is that the filter assembly 48 includes two male ends such that the filter assembly 48 can connect directly to the air delivery tube 42 without the use of the straight connector 66 shown in FIG. 7.

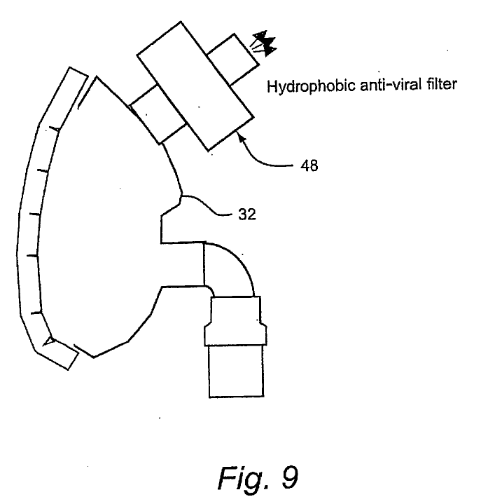

FIG. 9 illustrates a sixth embodiment of the present invention in which the mask shell 32 is provided with or connected to a filter assembly 48. Communication between the interior chamber of the mask assembly and the filter assembly 48 would require modification of the shell, for example, an aperture can be provided in the shell. In an alternative, the filter assembly could be configured to communicate with the mask shell interior via a pre-existing aperture found in vented masks available, e.g., from ResMed Limited. For example, the inlet side of the filter assembly may be configured to mate with a vent aperture as shown in Prior Art FIG. 1 (removal of the vent 20 would reveal the aperture).

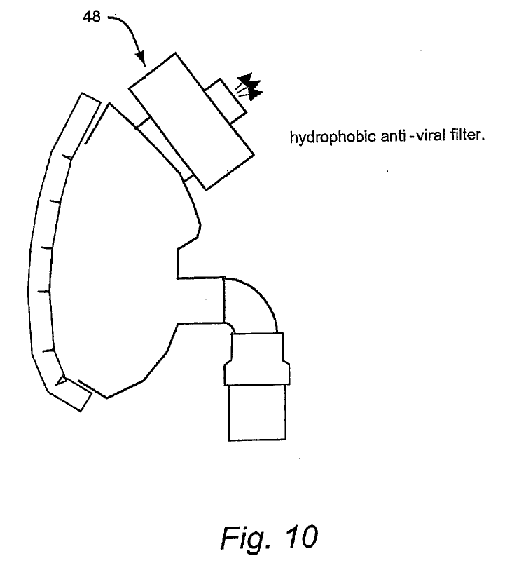

FIG. 10 shows a seventh embodiment of the present invention which is similar to that shown in FIG. 9. The main difference is that the filter assembly in FIG. 10 has a reduced profile such that it reduces possible interference with patient vision and it has less possibility of interfering with movement of the patient's head.

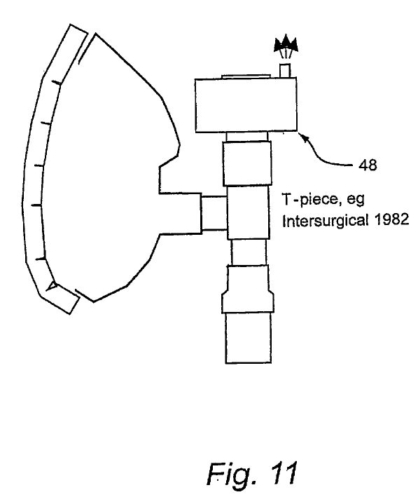

FIG. 11 illustrates an eighth embodiment of the present invention which is similar to that shown in FIG. 5. The main difference is that the vent assembly 48 in FIG. 11 has a low profile which is achieved, for example, by eliminating or reducing the height of the outlet tube 54 shown in FIG. 5.

In deciding which embodiment to use, several factors should be taken into consideration. For example, any filter used should have negligible, if any, effect on the air flow. This is less of a factor if it is only the vent flow that is being filtered. Moreover, the filter impedance should be predictable and relatively constant. Further, any potential possibility of CO₂ rebreathing should be eliminated or at least minimized to acceptable levels. Inclusion of the filter assembly should also have little or no adverse impact upon breath triggering sensitivity. Further, ultimate venting of the filtered air should be provided such that it does not produce an undesirable level of noise.

The filter should preferably have a viral efficiency of greater than 99.999%. For the embodiments of FIGS. 6-8, e.g., where the filter is between the source of pressurized gas and the patient, the impedance of the filter preferably should be as low as possible, and it should not exceed 2.0 cm H₂O at 60 1/min. flow. The flow impedance requirements can be slightly relaxed for other embodiments where only the vent flow is being filtered, e.g., see FIGS. 2, 5 and 9-11. The filter should have a resistance to blockage tested for a minimum of 24 hours continuous use without the filter impedance exceeding the requirements mentioned above. Of course, these values may change depending on application. The preferred filter is suitable for exhaled gas, that is it maintains efficiency in humid gases. One suitable example is a mechanical hydrophobic filter.

In general, full face mask systems used with positive airway pressure devices usually have a built in anti-asphyxia valve. Therefore, if the device stops delivering pressure, the anti-asphyxia valve allows the patient to breath room air rather than rebreathing exhaled air. The embodiments described above do not include an anti-asphyxia valve although they could be modified to include such. For example, the filter cap and/or the vent itself could include an anti-asphyxia valve. If an anti-asphyxia valve is not included, the mask system should preferably be used only in a controlled environment and strictly supervised.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the present invention. For example, while the embodiments of FIGS. 2-11 illustrate a fill face mask with a frontal inlet aperture, the filter assembly could be used in conjunction with a nasal or mouth only mask, nasal prongs, nasal pillows, nasal cannulae or a mask with an “over the head” type inlet as shown in FIG. 1, all of which are generally referenced to herein as a mask or mask assembly.

1. A mask assembly comprising:
a patient interface configured for connection to a patient in use, the patient interface being in communication with a source of gas pressurized above atmospheric pressure; and
a filter assembly configured to receive gas exhaled by the patient in use, whereby the exhaled gas is vented to atmosphere following passage through said filter assembly.

2. The mask assembly of claim 1, further comprising a connection joint defining a passage between the patient interface and the vent assembly.

3. The mask assembly of claim 2, wherein the connection joint comprises a T-shaped joint in which case the T-shaped joint is provided in use between the filter assembly and the source of pressurized gas.

4. The mask assembly of claim 2, wherein the connection joint is an L-shaped joint in which the filter assembly is positioned in use between the source of pressurized gas and the L-shaped joint.

5. The mask assembly according to claim 1, wherein the filter assembly includes an inlet to receive the gas exhausted by the patient, a central chamber, a filter provided in the central chamber, and an outlet configured to release the exhausted gas following filtering.

6. The mask assembly of claim 5, wherein the filter is made of a hydrophobic material.

7. The mask assembly according to claim 5, wherein the central chamber is provided with a calibration cap including one or more openings.

8. The mask assembly of claim 7, wherein the calibration cap includes a vent port in communication with the central chamber and a plug for said outlet.

9. The mask assembly according to claim 1, wherein the filter assembly includes an in-line vent positioned in use between the source of pressurized gas and the patient interface.

10. The mask assembly according to claim 1, wherein the filter assembly includes a filter.

11. The mask assembly according to claim 5, wherein the filter has a viral efficiency of greater than 99.999%.

12. The mask assembly according to claim 5, wherein the filter has an impedance of not greater than about 2.0 cm water at about 60 liters per minute.

13. The mask assembly of claim 1, wherein the filter assembly is positioned in use between the source of pressurized gas and the patient interface.

14. The mask assembly according to claim 1, further comprising an anti-asphyxia valve.

15. The mask assembly of claim 14, further comprising a filter cap provided to the filter assembly, wherein the anti-asphyxia valve is provided to the filter cap.

16. The mask assembly according to claim 14, further comprising a vent, wherein the anti-asphyxia valve is provided to the vent.
